(19) United States
(12) Patent Application Publication
(10) Pub. No.: US 2016/0147667 A1
(43) Pub. Date: May 26, 2016

(54) ADDRESS TRANSLATION IN MEMORY

(71) Applicant: Samsung Electronics Co., Ltd., Suwon-si (KR)

(72) Inventors: Manu AWASTHI, San Jose, CA (US); Kevin CHANG, Hillsborough, CA (US)

(21) Appl. No.: 14/813,111

(22) Filed: Jul. 29, 2015

Related U.S. Application Data
(60) Provisional application No. 62/083,887, filed on Nov. 24, 2014.

(51) Int. Cl. G06F 12/10; G06F 12/14

(52) U.S. Cl. CPC G06F 12/1009; G06F 12/145; G06F 2212/657; G06F 2212/651; G06F 2212/1052

(57) ABSTRACT

According to one general aspect, a computational memory may include memory cells configured to store data and a page table, wherein the page table maps, at least in part, a virtual address to a physical address. The computational memory may also include at least one processor-in-memory. Each processor-in-memory may be configured to: receive a request to execute an instruction utilizing the portion of the data stored by the memory cells, wherein the request includes the virtual address, request the physical address from a translator, and execute the instruction utilizing the physical address. The computational memory may further include the translator which may be configured to, for each processor-in-memory, convert, by accessing the page table, a virtual address associated with a portion of the data to a physical address associated with the portion of the data.

### CROSS-REFERENCE TO RELATED APPLICATION

This application claims priority under 35 U.S.C. §119 to Provisional Patent Application Ser. No. 62/083,887, entitled “ADDRESS TRANSLATION IN MEMORY” filed on Nov. 24, 2014. The subject matter of this earlier filed application is hereby incorporated by reference.

### TECHNICAL FIELD

This description relates to memory management, and more specifically to address translation.

### BACKGROUND

Most general purpose processors (CPU) implement some form of virtual memory. In computing, virtual memory is typically a memory management technique that is often implemented using both hardware and software. The technique maps memory addresses used by a program (called virtual addresses) into physical addresses used by the physical computer memory.

Address translation hardware in the CPU, often referred to as a memory management unit (MMU), automatically translates virtual addresses to physical addresses. Software within the operating system may extend these capabilities to provide a virtual address space that can exceed the capacity of main memory and thus reference more memory than is physically present in the computer.

The majority of implementations of virtual memory divide a virtual address space into pages or blocks of contiguous virtual memory addresses. Pages on contemporary systems are usually at least 4 kilobytes in size. Systems with large virtual address ranges or amounts of main memory generally use larger page sizes.

Page tables are often used to translate the virtual addresses seen by an application into the physical addresses used by the hardware to process instructions. The hardware that handles this specific translation is often integrated with the memory management unit or a translation look-aside buffer (TLB). Typically, each entry in the page table holds a flag indicating whether the corresponding page is in real memory or not. If it is in main memory, the page table entry will contain the real memory address at which the page is stored. When a reference is made to a page by the hardware, if the page table entry for the page indicates that it is not currently in real memory, the hardware raises a page fault exception.

Systems can have one page table for the whole system, separate page tables for each application and/or segment, a tree or hierarchy of page tables for large segments, or some combination of these. Generally, if there is only one page table, different applications running at the same time use different parts of a single range of virtual addresses. If there are multiple page or segment tables, there are multiple virtual address spaces and concurrent applications with separate page tables redirect to different real addresses.

### SUMMARY

According to one general aspect, a computational memory may include memory cells configured to store data and a page table, wherein the page table maps, at least in part, a virtual address to a physical address. The computational memory may also include at least one processor-in-memory. Each processor-in-memory may be configured to: receive a request to execute an instruction utilizing the portion of the data stored by the memory cells, wherein the request includes the virtual address, request the physical address from a translator, and execute the instruction utilizing the physical address. The computational memory may further include the translator which may be configured to, for each processor-in-memory, convert, by accessing the page table, a virtual address associated with a portion of the data to a physical address associated with the portion of the data.

According to another general aspect, a method of performing translation-in-memory by a computational memory may include receiving, from a processor, a translation request message, wherein the translation request message includes a virtual address. The method may also include converting the virtual address to a corresponding physical address by accessing only memory cells included in the computational memory. The method may further include transmitting, to the processor, a translation response message that includes either the physical address that corresponds to the virtual address or an error.

According to another general aspect, an apparatus may include an input/output decoder/encoder configured to: receive a translation request message, wherein the translation request message includes a virtual address, and transmit a translation response message that includes either a physical address that corresponds to the virtual address or an error. The apparatus may also include a translation-in-memory circuit configured to convert the virtual address to the physical address by accessing memory cells included by the apparatus.

The details of one or more implementations are set forth in the accompanying drawings and the description below. Other features will be apparent from the description and drawings, and from the claims.

A system and/or method for to memory management, and more specifically to address translation, substantially as shown in and/or described in connection with at least one of the figures, as set forth more completely in the claims.

### BRIEF DESCRIPTION OF THE DRAWINGS

FIG. 1 is a block diagram of an example embodiment of a system in accordance with the disclosed subject matter.

FIG. 2 is a block diagram of an example embodiment of an apparatus in accordance with the disclosed subject matter.

FIG. 3 is a block diagram of an example embodiment of an apparatus in accordance with the disclosed subject matter.

FIG. 4 is a block diagram of an example embodiment of an apparatus in accordance with the disclosed subject matter.

FIG. 5 is a block diagram of an example embodiment of a system in accordance with the disclosed subject matter.

FIG. 6 is a block diagram of an example embodiment of a system in accordance with the disclosed subject matter.

FIG. 7 is a flowchart of an example embodiment of a technique in accordance with the disclosed subject matter.

FIG. 8 is a schematic block diagram of an information processing system that may include devices formed according to principles of the disclosed subject matter.

Like reference symbols in the various drawings indicate like elements.

### DETAILED DESCRIPTION

Various example embodiments will be described more fully hereinafter with reference to the accompanying drawings, in which some example embodiments are shown. The present disclosed subject matter may, however, be embodied in many different forms and should not be construed as limited to the example embodiments set forth herein. Rather, these example embodiments are provided so that this disclosure will be thorough and complete, and will fully convey the scope of the present disclosed subject matter to those skilled in the art. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on”, “directly connected to” or “directly coupled to” another element or layer, there are no intervening elements or layers present. Like numerals refer to like elements throughout. As used herein, the term “and/or” includes any and all combinations of one or more of the associated listed items.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer, or section from another region, layer, or section. Thus, a first element, component, region, layer, or section discussed below could be termed a second element, component, region, layer, or section without departing from the teachings of the present disclosed subject matter.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular example embodiments only and is not intended to be limiting of the present disclosed subject matter. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of idealized example embodiments (and intermediate structures). As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present disclosed subject matter.

Unless otherwise defined, all terms (including technical and scientific terms) used herein have the same meaning as commonly understood by one of ordinary skill in the art to which this disclosed subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, example embodiments will be explained in detail with reference to the accompanying drawings.

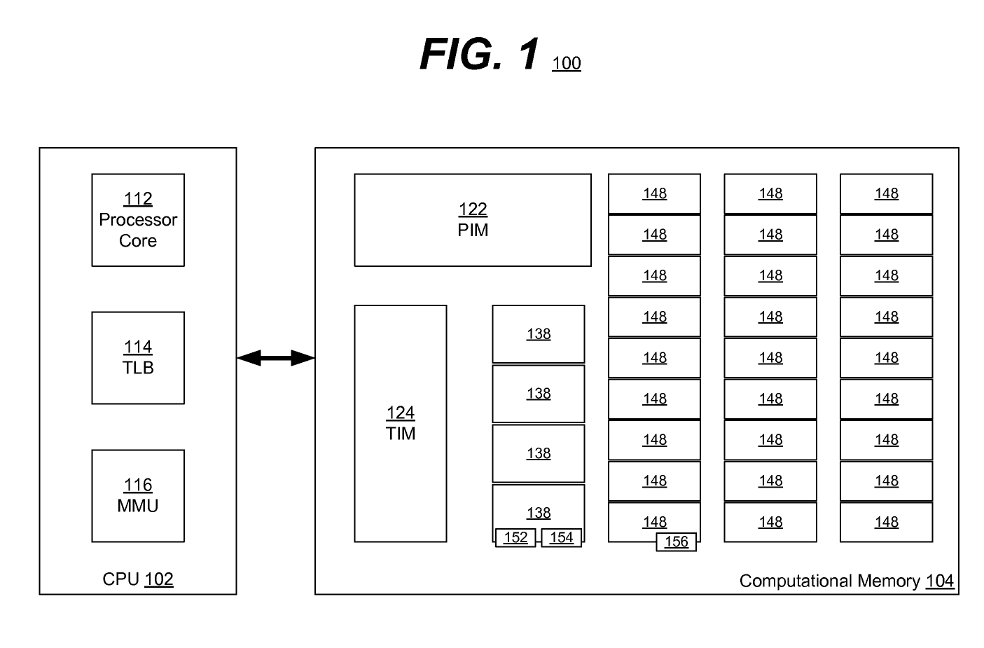

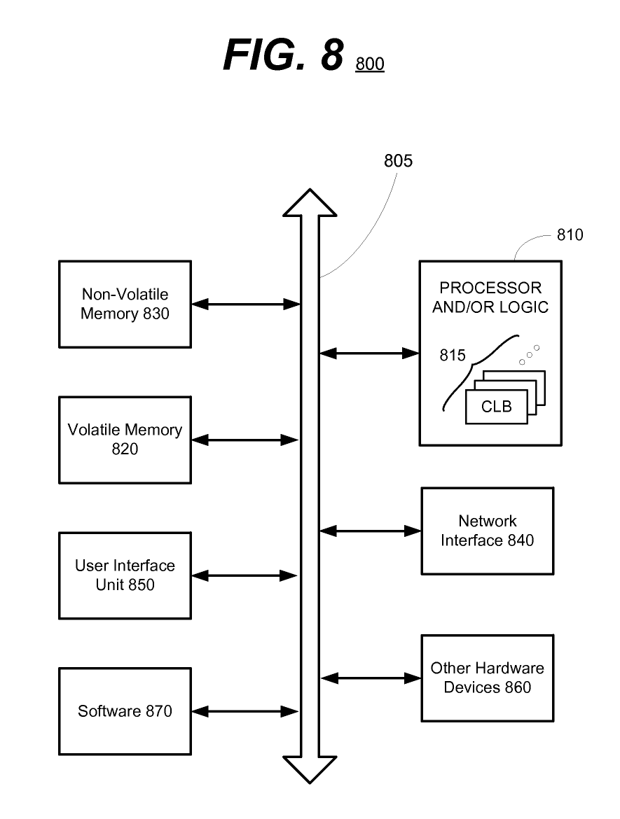

FIG. 1 is a block diagram of an example embodiment of a system 100 in accordance with the disclosed subject matter. In various embodiments, the system 100 may be part of a larger system (e.g., that of FIG. 8, etc.). In some embodiments, the system 100 may illustrate how a computational memory 104 may interact with an external processor (CPU) 102. It is understood that the above is merely one illustrative example to which the disclosed subject matter is not limited.

In various embodiments, the system 100 may include a processor (CPU) 102 and a memory 104. In various embodiments, the processor 102 may be configured to execute one or more machine executable instructions or pieces of software, firmware, or a combination thereof. The system 100 may include, in some embodiments, a memory 104 configured to store one or more pieces of data, either temporarily, permanently, semi-permanently, or a combination thereof. Further, the memory 104 may include volatile memory, non-volatile memory or a combination thereof. In various embodiments, the system 100 may include one or more other hardware components, that are not shown (e.g., a display or monitor, a network interface, a keyboard, a mouse, a camera, a fingerprint reader, a video processor, etc.). It is understood that the above are merely a few illustrative examples to which the disclosed subject matter is not limited.

In some embodiments, the system 100 may employ a paging scheme of a virtual memory. In such an embodiment, the software (executed by at least the processor 102) may make use of virtual addresses. In order for the processor 102 to access the data (or instructions) stored at the virtual addresses, these virtual addresses must be translated to physical addresses. These physical addresses may correspond to locations in the memory 104, specifically locations in the memory cells 148 which physically store that desired data.

In the illustrated embodiment, the paging scheme may store one or more page tables 138 in the memory 104. In various embodiments, the page tables 138 may include a hierarchy of page tables 138, such that non-leaf pages tables 138 (i.e., page tables that are not at the end of the hierarchy) include pointers or references to other page tables 138. It is understood that the above is merely one illustrative example to which the disclosed subject matter is not limited.

Traditionally, the CPU 102 may include one or more processor cores 112 that include various logic circuits that are employed to execute the desired instructions and access the desired data 156. At this stage, the desired data may be associated with a virtual address 152. In order for the desired data to actually be accessed an associated physical address 154 may need to be uncovered.

In such an embodiment, the CPU 102 may include a translation look-aside buffer (TLB) 114 configured to cache a set of virtual addresses and their corresponding physical addresses. If the desired virtual address is in the TLB 114 (a TLB hit), the corresponding physical address may be returned to the processor core 112, and the data may be retrieved from the memory 104 or the memory cells 148 of the memory 104. If the desired virtual address is not in the TLB 114 (a TLB miss), the TLB 114 (or more generally the MMU 116) may walk through the page tables 138 stored in the memory 104 to find the virtual address 152, and the corresponding physical address 154. If a TLB miss occurs, the resulting page walking may incur a number of transactions or messages between the CPU 102 and the memory 104. These transactions may be relatively expensive, both in terms of time and power consumed.

In various embodiments, the CPU 102 may include a memory management unit (MMU) 116. The MMU 116 may be configured to manage interactions between the CPU 102 and the memory 104. In some embodiments, the MMU 116 may include (either physically or conceptually) the TLB 114. Unlike the embodiment shown here, in some embodiments, the MMU 116 may not be integrated with the CPU 102.

In the illustrated embodiment, the memory 104 may include a processor 122. This may be referred to as a processor-in-memory (PIM) 122, as it is integrated with (e.g., either on-die or on-board, etc.) the memory cells 148, and therefore the data 156. In various embodiments, the execution of various instructions may be delegated to the PIM 122. In various embodiments, this may be beneficial because that data 156 associated with the instruction may be locally stored (within the memory 104), alleviating the need for data 156 to be transferred between the CPU 102 and the memory 104. Again, these transactions may be relatively expensive, both in terms of time and power consumed. Memories with PIM 122s may be referred to a computational memories or computational random access memories (RAMs).

In such an embodiment, the data 156 may be associated with a virtual address 152. Again, to access this data 156 a physical address 154 must be used.

Traditionally, to translate this virtual address 152 into a physical address 154, the PIM 122 would request a translation from the TLB 114 (included in the CPU 102). Even if a TLB hit occurred, this translation request/response transaction incurs a number of messages between the CPU 102 and the memory 104. These messages may be relatively expensive, both in terms of time and power consumed. If a TLB miss occurs, the number of messages may increase dramatically.

In the illustrated embodiment, the memory 104 may include a translator or translation-in-memory (TIM) 124. In such an embodiment, the TIM 124 may be configured to convert, by accessing the page tables 138, a virtual address 152 associated with a portion of the data 156 to a physical address 154 associated with the portion of the data 156.

In such an embodiment, the PIM 122 may send the translation request, not to the TLB 114, but instead to the TIM 124. In the illustrated embodiment, the TIM 124 may include caches or may walk through the page tables 138 (or use another technique), and convert the virtual address 152 supplied by the PIM 122 to a physical address 154. This may be done without involving the CPU 102 or any other component outside or external to the computational memory 104. This may remove or reduce the aforementioned messages that occur between the CPU and memory that are relatively expensive, both in terms of time and power consumed.

In another embodiment, the CPU 102 or MMU 116 may request a virtual-to-physical address translation from the TIM 124. In such an embodiment, the virtual-to-physical address translation may be done with two transactions or commutation packets. This is compared to a traditional TLB miss, in which the MMU 116 may require a relatively large number messages as it walks through the page tables 138, reading each page line and searching for the desired virtual address 152.

In various embodiments, the TIM 124's act of virtual-to-physical address translation may be done in a manner that is transparent to software. In such an embodiment, the software or instructions being executed by the processor core 112 or PIM 122 may be translated by with TLB 114/MMU 116 or the TIM 124, and the software may be agnostic as to the components used.

In the illustrated embodiment, a single memory 104 is shown. It is understood that in various embodiments, other or additional memories (not shown) may be employed, and the desired data may be stored in their memory cells (like memory cells 148) with corresponding physical addresses. In various embodiments, the other memories may include “dumb” memories (i.e., those without PIMs 112), or may include other computational memories (e.g., even those with or without TIMs 124, active or inactive). In various embodiments, the other memories may include a hierarchy of memories (e.g., caches, etc.) and/or heterogeneous memory systems. It is understood that the above are merely a few illustrative examples to which the disclosed subject matter is not limited.

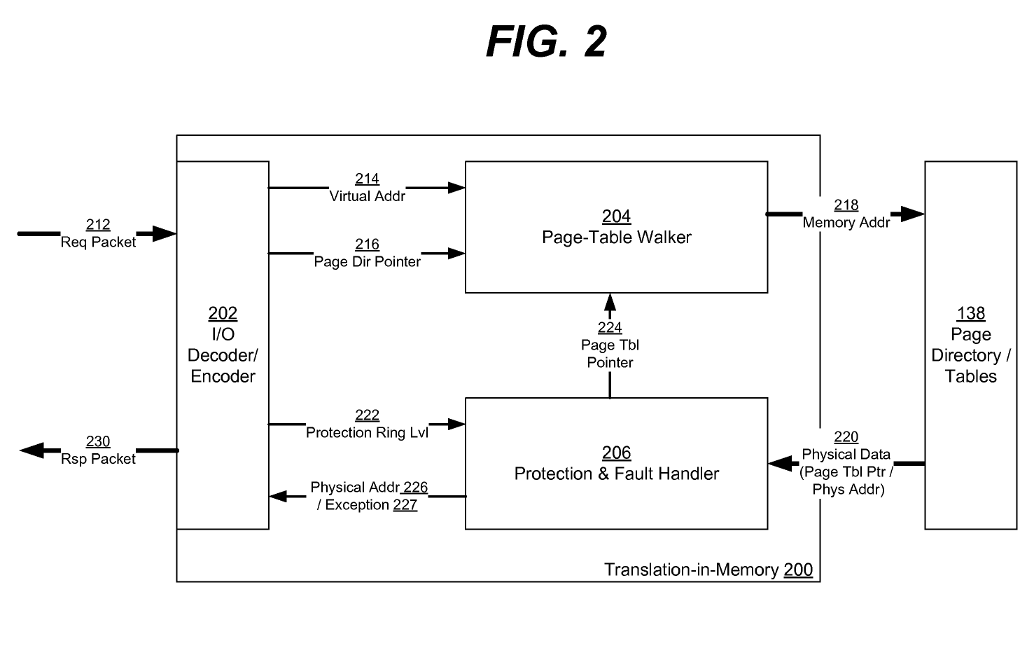

FIG. 2 is a block diagram of an example embodiment of an apparatus 200 in accordance with the disclosed subject matter. In various embodiments, the apparatus 200 may include a translation-in-memory (TIM). As described above, the TIM 200 may be included as part of a computational memory. Also as described above, the TIM 200 may be accessed by a PIM and/or a CPU.

In the illustrated embodiment, the TIM 200 may include an input/output (I/O or IO) decoder/encoder 202, a page-table walker 204, and a protection & fault handler 206. In such an embodiment, the IO decoder/encoder 202 may be configured to receive and transmit packets or messages to/from a processor (e.g., a CPU, a PIM, etc.). In various embodiments, the IO decoder/encoder 202 may receive a request packet 212 from the processor. In such an embodiment, the request packet 212 may include a request to translate a virtual address to a physical address.

In the illustrated embodiment, the page-table walker 204 may be configured to convert the virtual address to the physical address. In one embodiment, the page-table walker 204 may receive the virtual address 214 and a page table pointer. The virtual address 214 may have been included in the request packet 212. In one embodiment, a base page table or directory pointer 216 may have been included in the request packet 212 and may be the starting point to the page table hierarchy 138.

In various embodiments, the page-table walker 204 may use the page directory pointer 216 to access the page tables 138. The page-table walker 204 may then walk or read through the page tables 138, searching for the virtual address 214. In various embodiments, this may be an iterative process. Depending upon the structure of the page tables 138 (e.g., hierarchical or flat, etc.) and whether the current page table 138 includes the virtual address 214, the page tables 138 may return either the physical address or another page table pointer (illustrated as physical data 220). In such an embodiment, the new page table pointer may be a reference to another page table in the page table hierarchy 138.

In some embodiments, the protection and fault handler 206 may be configured to determine if the instruction (that caused the virtual-to-physical address translation request 212) is allowed to access the data stored at the physical address. In the illustrated embodiment, the protection and fault handler 206 may receive a security identifier, or in one embodiment a protection ring level 222. In such an embodiment, this security identifier 222 may have been included in the request packet 212. The security identifier 212 may indicate what access or security privileges the instruction has.

The protection and fault handler 206 may be configured to receive the physical data 220 received from the page tables 138 in response to the page-table walker 204's activity. In the illustrated embodiment, if the physical data 220 is merely a second (or subsequent) page table pointer 224, this may be relayed to the page-table walker 204 and the page-table walker 204 may continue to walk the page tables 138. In another embodiment, this routing of the physical data 220 (between pointer and address) may occur outside the protection and fault handler 206.

If the physical data 220 includes a physical address, the protection and fault handler 206 may be configured to determine if the physical address is associated with the security identifier 222. If the instruction, as determined by the association between the security identifier 222 and the physical address, is allowed to access the data stored at the physical address, the protection and fault handler 206 may pass the physical address 226 to the IO decoder/encoder 202. On the other hand, if the instruction is not allowed to access the data, the protection and fault handler 206 may generate a security exception 227. This security exception 227 may then be passed to the IO decoder/encoder 202.

Upon receipt of either the physical address 226 or the security exception 227, the IO decoder/encoder 202 may be configured to generate a response packet 230. The response packet 230 may include either the received physical address 226 or the security exception 227. The response packet 230 may be transmitted to the requesting processor (e.g., CPU, PIM, etc.) where the processor may either access the data using the physical address 226 or process the security exception 227.

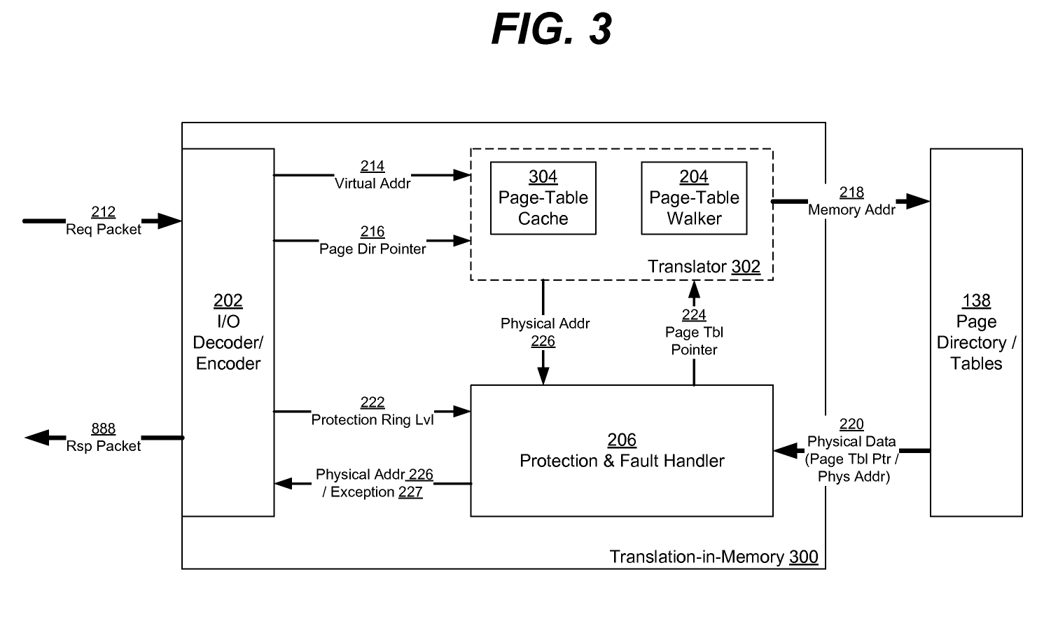

FIG. 3 is a block diagram of an example embodiment of an apparatus 300 in accordance with the disclosed subject matter. In various embodiments, the apparatus 300 may include a translation-in-memory (TIM). As described above, the TIM 300 may be included as part of a computational memory. Also as described above, the TIM 300 may be accessed by a PIM and/or a CPU.

In the illustrated embodiment, the TIM 300 may include an input/output (I/O or IO) decoder/encoder 202, and a protection & fault handler 206. In such an embodiment, the IO decoder/encoder 202 may be configured to receive and transmit packets or messages to/from a processor (e.g., a CPU, a PIM, etc.), as described above.

In the illustrated embodiment, the TIM 300 may include a translator 302. In such an embodiment, the translator 302 may include a page-table walker 204, as described above. However, in various embodiments, the translator 302 may also include a page-table cache 304 configured to cache virtual addresses and their corresponding physical addresses. As the page-table walker 204 converts virtual addresses into physical addresses, that mapping may be stored in the page-table cache 304. When a subsequent virtual-to-physical address translation request 212 is made, the translator 302 may look into the page-table cache 304 to see if the virtual address has already been mapped to a physical address. If so, the stored or cached physical address 226 may be returned to the protection & fault handler 206 (or directly to the IO decoder/encoder 202). If not, the virtual address 214 and table directory pointer 216 may be passed to the page-table walker 204.

In some embodiments, the page-table cache 304 may include a translation look-aside buffer. In another embodiment, other caching structures may be employed. It is understood that the above are merely a few illustrative examples to which the disclosed subject matter is not limited.

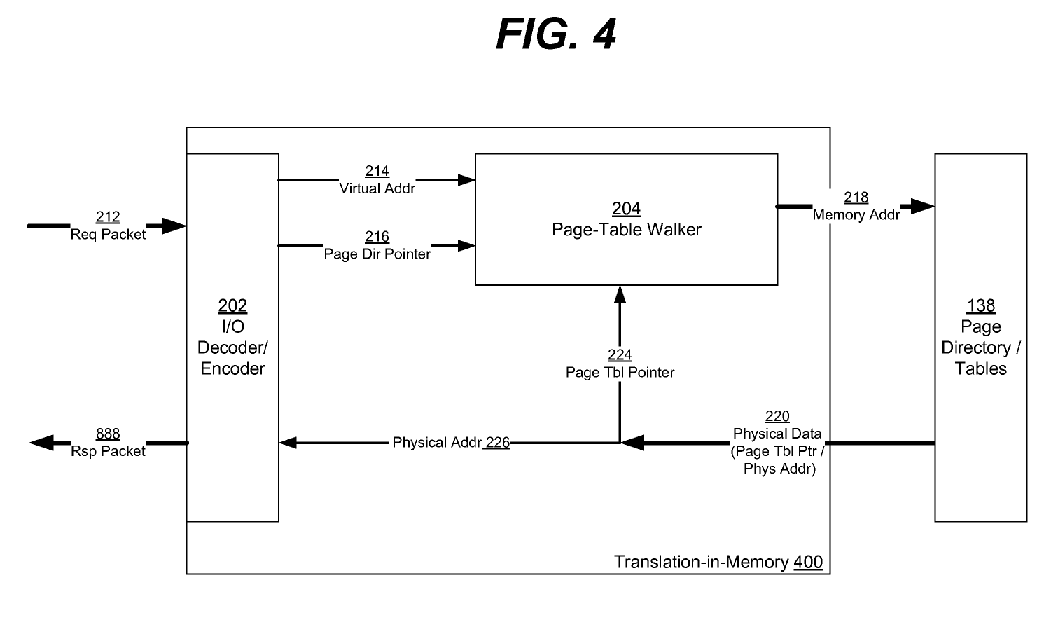

FIG. 4 is a block diagram of an example embodiment of an apparatus 400 in accordance with the disclosed subject matter. In various embodiments, the apparatus 400 may include a translation-in-memory (TIM). As described above, the TIM 400 may be included as part of a computational memory. Also as described above, the TIM 400 may be accessed by a PIM and/or a CPU.

In the illustrated embodiment, the TIM 400 may include an input/output (I/O or IO) decoder/encoder 202, and a page-table walker 204. In such an embodiment, the TIM 400 may not include the protection and fault handler described above. In such an embodiment, when the page table 138 returns a page table pointer 224, the page table pointer 224 may be routed directly to the page-table walker 204 (or, in another embodiment, a translator such as shown in FIG. 3) Likewise, when the page table 138 returns a physical address 226, the physical address 226 may be routed directly to the IO decoder/encoder 202. In such an embodiment, the requesting processor may be responsible for checking of the instruction is allowed to access the psychical address 226.

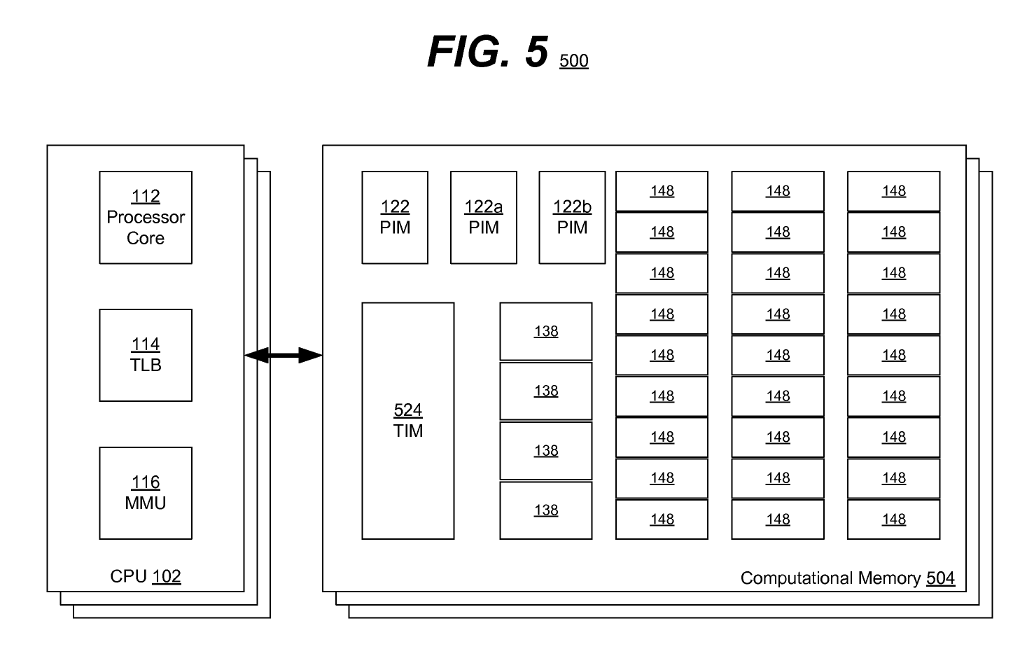

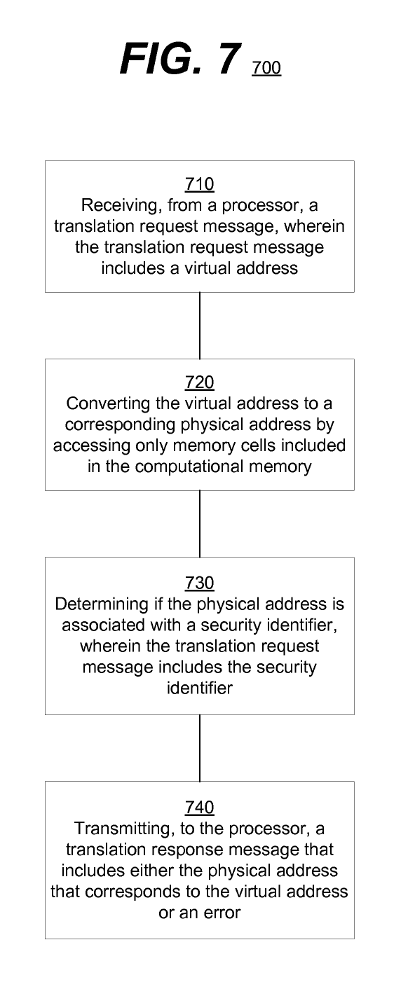

FIG. 5 is a block diagram of an example embodiment of a system 500 in accordance with the disclosed subject matter. In various embodiments, the system 100 may be part of a larger system (e.g., that of FIG. 7, etc.). It is understood that the above is merely one illustrative example to which the disclosed subject matter is not limited.

In various embodiments, the system 100 may include a processor (CPU) 102 and a computational memory 504. In the illustrated embodiment, the computational memory 504 may include a plurality of PIMs 122, 122a, and 122b, etc. In such an embodiment, each of the PIMs 122, 122a, and 122b may access the TIM 524. The TIM 524 may be configured to service multiple simultaneous virtual-to-physical address translation requests, and may be configured to service those requests from multiple processors (e.g., CPU 102, PIM 122, PIM 122a, PIM 122b, etc.).

Further, in various embodiments, the TIM 524 may be configured to process virtual-to-physical address translation requests from other CPUs 102 (e.g., multi-CPU systems) and/or PIMs that are included in other computational memories 504. In one embodiment, the TIM 524 may be implemented as a special purpose version of a PIM 122. It is understood that the above are merely a few illustrative examples to which the disclosed subject matter is not limited.

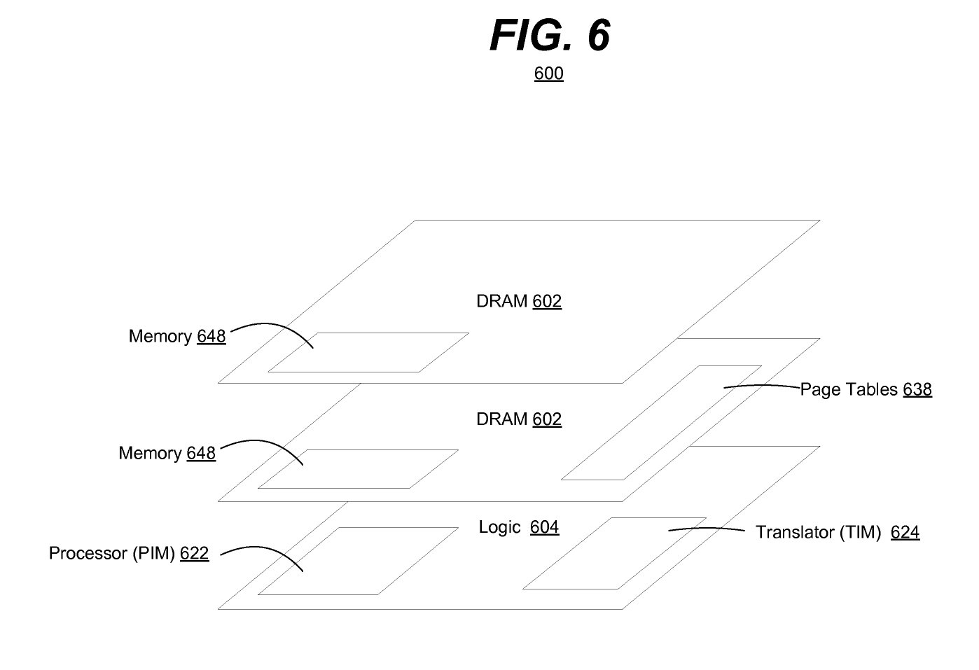

FIG. 6 is a block diagram of an example embodiment of a system 600 in accordance with the disclosed subject matter. In various embodiments, memories may be created by using multi-chip modules. This may include fabricating the circuits on a respective dies, and then coupling the dies together to form an integrated device.

In the illustrated embodiment, the system 600 may include a plurality of memory array dies 602. Each memory array die 602 may include memory cells 648 that may be used to store data and/or instructions. In the illustrated embodiment, one or more of the memory array dies 602 may include memory cells 638 that may be used to store page tables. In the illustrated embodiment, the memory array die 602 may include dynamic random access memory (DRAM) cells. In another embodiment, other memory cells (e.g., static RAM (SRAM), Magnetoresistive RAM (MRAM), Phase-change RAM (PRAM), NAND or flash memory (e.g., SSD, etc.), Resistive RAM (RRAM), etc.) may be employed. It is understood that the above are merely a few illustrative examples to which the disclosed subject matter is not limited.

In various embodiments, the system 600 may include a logic die 604 that includes circuits that implement the PIM 622 and a TIM 624. In various embodiments, the logic die 604 may be fabricated using the same technology or manufacturing process as the memory array die(s) 502. It is understood that the above is merely one illustrative example to which the disclosed subject matter is not limited.

In the illustrated embodiment, the logic die 604 may be placed on the bottom of the die stack. In such an embodiment, one or more memory array dies 602 may be placed above the logic die 604. In various embodiments, the page tables 638 may be stored in memory cells spatially close to the TIM 624 in order to facilitate the walking of the page tables 638 and the virtual-to-physical address translation. It is understood that the above are merely a few illustrative examples to which the disclosed subject matter is not limited.

FIG. 7 is a flow chart of an example embodiment of a technique in accordance with the disclosed subject matter. In various embodiments, the technique 700 may be used or produced by the systems such as at least one of the figures described herein. Although, it is understood that the above are merely a few illustrative examples to which the disclosed subject matter is not limited. It is understood that the disclosed subject matter is not limited to the ordering of or number of actions illustrated by technique 700.

Block 710 illustrates that, in one embodiment, a translation request message may be received from a processor, as described above. In some embodiments, the translation request message includes a virtual address, as described above. In one embodiment, receiving may include a translation request message from a processor-in-memory that is included by a computational memory, as described above. In another embodiment, receiving may include receiving a translation request message from a memory management unit that is external to the computational memory, as described above.

Block 720 illustrates that, in one embodiment, the virtual address may be converted to a corresponding physical address by accessing memory cells included in the computational memory, as described above. In some embodiments, converting may include iteratively walking through page tables stored by the computational memory. In such an embodiment, converting may also include, when the virtual address is found in the page tables, retrieving the physical address from the page tables, as described above.

Block 730 illustrates that, in one embodiment, it may be determined if the physical address is associated with a security identifier, as described above. In such an embodiment, the translation request message may include the security identifier.

Block 740 illustrates that, in one embodiment, a translation response message may be transmitted to the processor, as described above. In various embodiments, the translation response message may include either the physical address that corresponds to the virtual address or an error message, as described above. In some embodiments, if the physical address is associated with a security identifier, the physical address may be included in the translation response message, as described above. In various embodiments, if the physical address is not associated with a security identifier, the error may be included in the translation response message, as described above.

FIG. 8 is a schematic block diagram of an information processing system 800, which may include semiconductor devices formed according to principles of the disclosed subject matter.

Referring to FIG. 8, an information processing system 800 may include one or more of devices constructed according to the principles of the disclosed subject matter. In another embodiment, the information processing system 800 may employ or execute one or more techniques according to the principles of the disclosed subject matter.

In various embodiments, the information processing system 800 may include a computing device, such as, for example, a laptop, desktop, workstation, server, blade server, personal digital assistant, smartphone, tablet, and other appropriate computers, etc. or a virtual machine or virtual computing device thereof. In various embodiments, the information processing system 800 may be used by a user (not shown).

The information processing system 800 according to the disclosed subject matter may further include a central processing unit (CPU), logic, or processor 810. In some embodiments, the processor 810 may include one or more functional unit blocks (FUBs) or combinational logic blocks (CLBs) 815. In such an embodiment, a combinational logic block may include various Boolean logic operations (e.g., NAND, NOR, NOT, XOR, etc.), stabilizing logic devices (e.g., flip-flops, latches, etc.), other logic devices, or a combination thereof. These combinational logic operations may be configured in simple or complex fashion to process input signals to achieve a desired result. It is understood that while a few illustrative examples of synchronous combinational logic operations are described, the disclosed subject matter is not so limited and may include asynchronous operations, or a mixture thereof. In one embodiment, the combinational logic operations may comprise a plurality of complementary metal oxide semiconductors (CMOS) transistors. In various embodiments, these CMOS transistors may be arranged into gates that perform the logical operations; although it is understood that other technologies may be used and are within the scope of the disclosed subject matter.

The information processing system 800 according to the disclosed subject matter may further include a volatile memory 820 (e.g., a Random Access Memory (RAM), etc.). The information processing system 800 according to the disclosed subject matter may further include a non-volatile memory 830 (e.g., a hard drive, an optical memory, a NAND or Flash memory, etc.). In some embodiments, either the volatile memory 820, the non-volatile memory 830, or a combination or portions thereof may be referred to as a “storage medium”. In various embodiments, the volatile memory 820 and/or the non-volatile memory 830 may be configured to store data in a semi-permanent or substantially permanent form.

In various embodiments, the information processing system 800 may include one or more network interfaces 840 configured to allow the information processing system 800 to be part of and communicate via a communications network. Examples of a Wi-Fi protocol may include, but are not limited to, Institute of Electrical and Electronics Engineers (IEEE) 802.11g, IEEE 802.11n, etc. Examples of a cellular protocol may include, but are not limited to: IEEE 802.16m (a.k.a. Wireless-MAN (Metropolitan Area Network) Advanced), Long Term Evolution (LTE) Advanced), Enhanced Data rates for GSM (Global System for Mobile Communications) Evolution (EDGE), Evolved High-Speed Packet Access (HSPA+), etc. Examples of a wired protocol may include, but are not limited to, IEEE 802.3 (a.k.a. Ethernet), Fibre Channel, Power Line communication (e.g., HomePlug, IEEE 1901, etc.), etc. It is understood that the above are merely a few illustrative examples to which the disclosed subject matter is not limited.

The information processing system 800 according to the disclosed subject matter may further include a user interface unit 850 (e.g., a display adapter, a haptic interface, a human interface device, etc.). In various embodiments, this user interface unit 850 may be configured to either receive input from a user and/or provide output to a user. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

In various embodiments, the information processing system 800 may include one or more other devices or hardware components 860 (e.g., a display or monitor, a keyboard, a mouse, a camera, a fingerprint reader, a video processor, etc.). It is understood that the above are merely a few illustrative examples to which the disclosed subject matter is not limited.

The information processing system 800 according to the disclosed subject matter may further include one or more system buses 805. In such an embodiment, the system bus 805 may be configured to communicatively couple the processor 810, the volatile memory 820, the non-volatile memory 830, the network interface 840, the user interface unit 850, and one or more hardware components 860. Data processed by the processor 810 or data inputted from outside of the non-volatile memory 830 may be stored in either the non-volatile memory 830 or the volatile memory 820.

In various embodiments, the information processing system 800 may include or execute one or more software components 870. In some embodiments, the software components 870 may include an operating system (OS) and/or an application. In some embodiments, the OS may be configured to provide one or more services to an application and manage or act as an intermediary between the application and the various hardware components (e.g., the processor 810, a network interface 840, etc.) of the information processing system 800. In such an embodiment, the information processing system 800 may include one or more native applications, which may be installed locally (e.g., within the non-volatile memory 830, etc.) and configured to be executed directly by the processor 810 and directly interact with the OS. In such an embodiment, the native applications may include pre-compiled machine executable code. In some embodiments, the native applications may include a script interpreter (e.g., C shell (csh), AppleScript, AutoHotkey, etc.) or a virtual execution machine (VM) (e.g., the Java Virtual Machine, the Microsoft Common Language Runtime, etc.) that are configured to translate source or object code into executable code which is then executed by the processor 810.

The semiconductor devices described above may be encapsulated using various packaging techniques. For example, semiconductor devices constructed according to principles of the disclosed subject matter may be encapsulated using any one of a package on package (POP) technique, a ball grid arrays (BGAs) technique, a chip scale packages (CSPs) technique, a plastic leaded chip carrier (PLCC) technique, a plastic dual in-line package (PDIP) technique, a die in waffle pack technique, a die in wafer form technique, a chip on board (COB) technique, a ceramic dual in-line package (CERDIP) technique, a plastic metric quad flat package (PMQFP) technique, a plastic quad flat package (PQFP) technique, a small outline package (SOIC) technique, a shrink small outline package (SS OP) technique, a thin small outline package (TS OP) technique, a thin quad flat package (TQFP) technique, a system in package (SIP) technique, a multi-chip package (MCP) technique, a wafer-level fabricated package (WFP) technique, a wafer-level processed stack package (WSP) technique, or other technique as will be known to those skilled in the art.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

In various embodiments, a computer readable medium may include instructions that, when executed, cause a device to perform at least a portion of the method steps. In some embodiments, the computer readable medium may be included in a magnetic medium, optical medium, other medium, or a combination thereof (e.g., CD-ROM, hard drive, a read-only memory, a flash drive, etc.). In such an embodiment, the computer readable medium may be a tangibly and non-transitorily embodied article of manufacture.

While the principles of the disclosed subject matter have been described with reference to example embodiments, it will be apparent to those skilled in the art that various changes and modifications may be made thereto without departing from the spirit and scope of these disclosed concepts. Therefore, it should be understood that the above embodiments are not limiting, but are illustrative only. Thus, the scope of the disclosed concepts are to be determined by the broadest permissible interpretation of the following claims and their equivalents, and should not be restricted or limited by the foregoing description. It is, therefore, to be understood that the appended claims are intended to cover all such modifications and changes as fall within the scope of the embodiments.

What is claimed is:

1. A computational memory comprising:
memory cells configured to store data and a page table, wherein the page table maps, at least in part, a virtual address to a physical address;
at least one processor-in-memory each configured to:
receive a request to execute an instruction utilizing the portion of the data stored by the memory cells, wherein the request includes the virtual address,
request the physical address from a translator, and
execute the instruction utilizing the physical address; and
the translator configured to, for each processor-in-memory, convert, by accessing the page table, a virtual address associated with a portion of the data to a physical address associated with the portion of the data.

2. The computer memory of claim 1, wherein the translator is configured to:
receive a second translation request originating from a central processor external to the computational memory, wherein the second translation request includes a second virtual address; and
convert, by accessing the page table, the second virtual address to a second physical address; and
transmit the second physical address to the central processor.

3. The computational memory of claim 1, wherein the computational memory comprises an input/output decoder/encoder configured to:
receive a translation request message, wherein the translation request message includes a virtual address, and
transmit a translation response message that includes either a physical address that corresponds to the virtual address or an error.

4. The computational memory of claim 1, wherein the translator is configured to convert the virtual address to the physical address without the assistance of a component external to the computational memory.

5. The computational memory of claim 1, further comprising a page table walker configured to convert the virtual address the data to the physical address;
wherein the page table walker receives the virtual address and a page table pointer;
wherein the page table walker is configured to access the page table via the page table pointer, and search for the virtual address in the page table; and
wherein the page table walker is configured to, in response, receive either a physical address or a second page table pointer.

6. The computational memory of claim 5, further comprising a protection and fault handler configured to determine if the instruction is allowed to access the data stored at the physical address; and
wherein the protection & fault handler is configured to:
receive the physical address and a security identifier associated with instruction,
determine if the physical address is associated with the security identifier, and
if the physical address is not associated with the security identifier, generate a security exception.

7. The computational memory of claim 5, further comprising a cache configured to map virtual address to physical addresses; and
wherein the translator is configured to:
determine if the virtual address is stored in the cache,
if not, convert the virtual address to the physical address via the page table walker,
if so, convert the virtual address to the physical address via the cache, and
store a mapping of the virtual address to the physical address in the cache after the translator has converted the virtual address to the physical address.

8. The computational memory of claim 1, wherein the translator is configured to return the physical address without determining if the instruction is allowed to access the data stored at the physical address.

9. The computational memory of claim 1, wherein the translator is configured to iteratively walk through the page table until the virtual address is found in order to convert the virtual address to the physical address.

10. The computational memory of claim 1, further comprising:
a first integrated circuit die that comprises the translator and the processor, and
at least a second integrated circuit die that comprises the memory cells; and
wherein the first integrated circuit die and the second integrated circuit die are coupled to form a stack of dies.

11. A method of performing translation-in-memory by a computational memory, the method comprising:
receiving, from a processor, a translation request message, wherein the translation request message includes a virtual address;
converting the virtual address to a corresponding physical address by accessing only memory cells included in the computational memory; and
transmitting, to the processor, a translation response message that includes either the physical address that corresponds to the virtual address or an error.

12. The method of claim 11, wherein receiving comprises receiving a translation request message from a processor-in-memory that is included by the computational memory.

13. The method of claim 11, wherein the receiving comprises receiving a translation request message from a memory management unit that is external to the computational memory.

14. The method of claim 11, wherein converting comprises:
iteratively walking through page tables stored by the computational memory; and
when the virtual address is found in the page tables, retrieving the physical address from the page tables.

15. The method of claim 11, further comprising determining if the physical address is associated with a security identifier, wherein the translation request message includes the security identifier; and
wherein transmitting a translation response message comprises:
if the physical address is associated with a security identifier, including the physical address in the translation response message, and
if the physical address is not associated with a security identifier, including the error in the translation response message.

16. An apparatus comprising:
an input/output decoder/encoder configured to:
receive a translation request message, wherein the translation request message includes a virtual address, and
transmit a translation response message that includes either a physical address that corresponds to the virtual address or an error; and
a translation-in-memory circuit configured to convert the virtual address to the physical address by accessing memory cells included by the apparatus.

17. The apparatus of claim 16, further including a protection and fault handler circuit configured to:
receive a security identifier, wherein the translation request message includes the security identifier,
receive the physical address,
determine if the physical address is associated with the security identifier, and
if the physical address is not associated with the security identifier, generate an security exception.

18. The apparatus of claim 16, wherein the translation request message includes a page table pointer; and
wherein the translation-in-memory circuit comprises a page table walker configured to:
access, via the page table pointer, a page table stored in the memory cells,
search for the virtual address in the page table, and
receive, from the page table, the physical address.

19. The apparatus of claim 18, wherein the translation-in-memory circuit comprises a cache configured to map virtual address to physical addresses; and
wherein the translation-in-memory circuit is configured to:
determine if the virtual address is stored in the cache,
if not, convert the virtual address to the physical address via the page table walker,
if so, convert the virtual address to the physical address via the cache, and
store a mapping of the virtual address to the physical address in the cache after the translation-in-memory circuit has converted the virtual address to the physical address.

20. The apparatus of claim 16, the input/output decoder/encoder is configured to receive the translation request message from a processor-in-memory that is integrated with the apparatus; and
wherein the apparatus is included by a computational memory that includes memory cells configured to store a page table and data.
